(19) United States
(12) Patent Application Publication
(10) Pub. No.: US 2015/0075351 A1
(43) Pub. Date: Mar. 19, 2015

(54) Stringed Instrument Improvement

(71) Applicant: Brent Douglas Deck, Kansas City, KS (US)

(72) Inventor: Brent Douglas Deck, Kansas City, KS (US)

(21) Appl. No.: 14/451,450

(22) Filed: Aug. 5, 2014

Related U.S. Application Data
(63) Continuation-in-part of application No. 13/494,007, filed on Jun. 11, 2012, now Pat. No. 8,796,524.
Application No. 13/494,007 is a continuation-in-part of application No. 13/424,357, filed on Mar. 19, 2012, now abandoned.
(60) Provisional application No. 61/500,137, filed on Jun. 23, 2011.
(60) Provisional application No. 61/511,979, filed on Jul. 26, 2011.
(60) Provisional application No. 61/529,910, filed on Aug. 31, 2011.
(60) Provisional application No. 61/454,495, filed on Mar. 18, 2011.

(51) Int. Cl. G10D 3/14

(52) U.S. Cl. CPC G10D 3/146
USPC 84/313

(57) ABSTRACT

This invention relates to improvements to a stringed musical instrument, and more particularly to guitar design for use with transposing vibrato mechanisms.

Vibrato devices for guitars are known. The present device and method improve the ability to of a player to bend entire chords in a manner that maintains harmonic relationship between the individual strings.

The invention also included improved manual controls and means to extend the transposing range of such a vibrato device.

This application claims priority to U.S. provisional application 61/838,338 filed Jun. 23, 2013 by the same applicant.

This application is a continuation in part of U.S. non-provisional application Ser. No. 13/494,007 filed Jun. 11, 2012 by the present applicant, issued Aug. 5, 2014, as U.S. Pat. No. 8,796,524, which was a continuation in part of U.S. non-provisional application Ser. No. 13/424,357 filed Mar. 19, 2012 by the present applicant, and which claimed priority to U.S. provisional application 61/454,495 filed Mar. 18, 2011 by the same applicant.

The disclosure of this application incorporates by reference the entirety of said U.S. application Ser. No. 12/842,028 filed Jul. 22, 2010, U.S. provisional application 61/529,910 filed Aug. 31, 2011, U.S. non-provisional application Ser. No. 13/494,007 filed Jun. 11, 2012, U.S. non-provisional application Ser. No. 14/085,790 filed Nov. 20, 2013, U.S. non-provisional application Ser. No. 14/325,305 filed Jul. 7, 2014, and U.S. Pat. No. 8,796,524 issued Aug. 5, 2014.

The disclosure of this application is also supplemented by incorporation by reference to every claim previously submitted during prosecution of the said U.S. applications Ser. Nos. 12/842,028 and 13/494,007.

Said incorporation by reference shall supplement the present disclosure without in any way limiting the scope or meaning of the disclosure or claims of the present application or subsequent applications.

### FIELD OF INVENTION

The present invention relates to devices which enhance the expressive qualities of a stringed musical instrument by empowering the artist to “bend” notes and chords in a harmonic manner.

### SUMMARY

The application discloses various embodiments having guides adjustably fixed relative to a pivoting tailpiece, causing the strings to be stretched or relaxed when the tailpiece is rotated, enabling maintenance of relative pitch among strings.

The application discloses dual axis control, enabling a musician to sweep easily from “bend” to “dive” (sharp to flat) while using the muscles on only one side of the hand and wrist. Dual axis control further allows biasing a tailpiece against a separate stop on a separate axis after either a bend or a dive, with enhanced stability at neutral pitch, and requiring no locking mechanism.

The application discloses various embodiments of a cam-enabled return spring to maintain neutral tuning when the device is released without adversely affecting motion of the device.

Embodiments also include a beneficial combination of pitch-relative and non-pitch-relative vibrato means, where a non-pitch-relative vibrato displacement may be used to compensate for non-linearities in string tension while transposing over large spans.

Also disclosed are various embodiments enabling improved electronic control, improved limitation on string stress, improved float about a neutral position, improved flex compensation, improved string anchoring, improved fulcrum support, and improved bending means for individual strings.

### BRIEF DESCRIPTION OF DRAWINGS

FIGS. 1 through 11 are perspective views of various embodiments of a neck mount bracket.

FIG. 12 is an end view of an embodiment of a guitar body and neck connected by a bracket.

FIG. 13 is an bottom view of an embodiment of a guitar body and neck connected by a bracket.

FIG. 14 is an end view of an embodiment of a guitar body and neck connected by a bracket.

FIG. 15 is an bottom view of an embodiment of a guitar body and neck connected by a bracket.

FIG. 16 is a cross sectional end view of an embodiment of a guitar body and neck connected by a bracket including keying means.

FIG. 17 is an bottom view of an embodiment of a guitar body and neck connected by a bracket including keying means.

FIG. 18 is a side view of an embodiment of a fretboard extender.

FIG. 19 is a side view an embodiment of a body, neck, and fretboard extender connected to an embodiment of a bracket.

FIG. 20 is a side view an embodiment of a body and neck connected to an embodiment of a bracket.

FIG. 21 is a side view an embodiment of a body and neck connected to an embodiment of a bracket.

FIG. 22 is a side view of an embodiment of a fretboard extender.

FIGS. 23 and 24 are side views of vibrato means having tension limiting means for one or more strings.

FIGS. 25A and 25B are end and bottom views of an instrument with a substantially flat (preferably a high modulus composite) plate keyed on two edges into an instrument body, secured for example by adhesive means

FIG. 26A shows an end view of an embodiment of a vibrato control arm having a rotational axis substantially parallel to the stings, where the body is cutaway to show an embodiment of vibrato connection and biasing means.

FIG. 26B show a top view of an embodiment of a vibrato control arm having a rotational axis substantially parallel to the stings, and of drum on an axis substantially parallel to the strings for manipulating an electronic rotation sensor.

FIG. 26C shows an end view of an embodiment of a vibrato control having a rotational axis substantially parallel to the stings, where the control comprises at least a partially arcuate surface.

FIG. 26D shows an end view of an embodiment of a vibrato control having a rotational axis substantially parallel to the stings, where the control arm comprises a substantially planar surface

FIG. 26E is a top view of an embodiment substantially similar to that of FIG. 26B.

### DISCUSSION

Parallel Control Axis

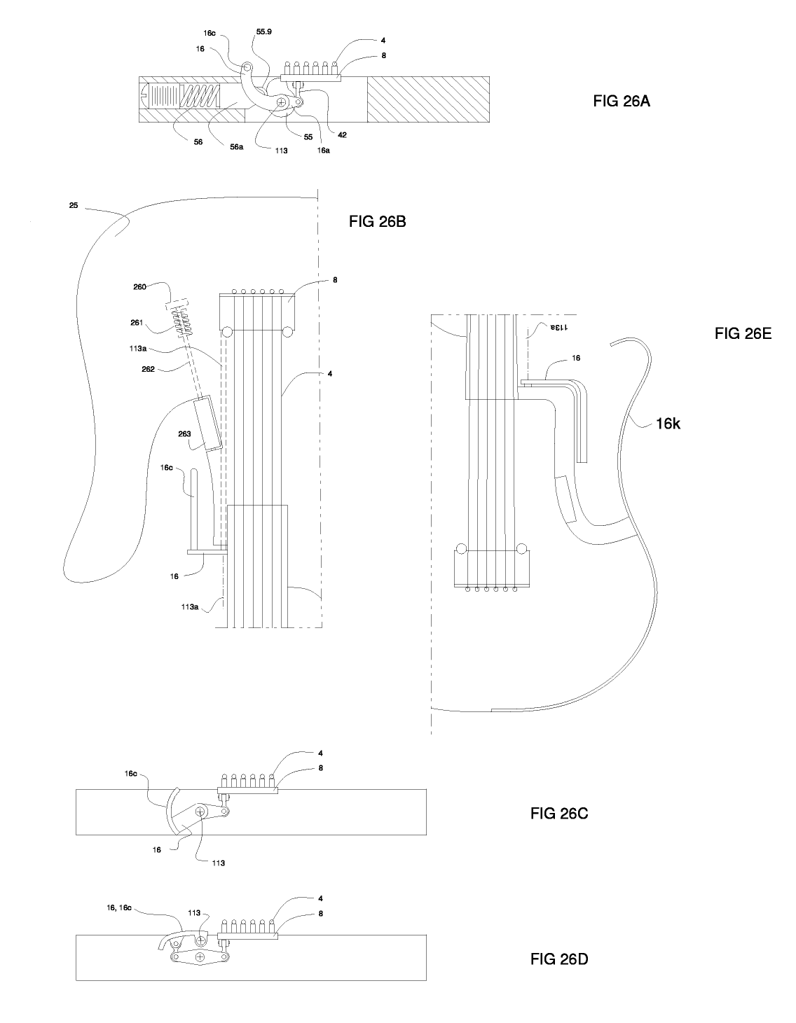

FIGS. 26A and 26B illustrate an example where the pivot means is a shaft 113a rotating on axis 113, preferably substantially below and parallel to the strings. An arm 16, preferably curved to provide suitable neck and body clearance, radiates from said shaft, having a handle 16c, also preferably parallel the strings 4.

The shaft engages the vibrato unit by suitable means, for example by a connecting rod 42 pivoting on crank arm 16a extending from the shaft 113a, and attached to a moveable member 8, as illustrated in FIG. 26A.

The device may utilize any biasing means, e.g. simple bias springs (not shown) connecting the rotating member 8 or a crank from shaft 113a to the instrument body 25.

In the example shown in FIG. 26A, the biasing means for the vibrato rotating member 8 is provided by return spring 56 pressing cam follower 55.9 toward cam 55, also rigidly attached to shaft 113a. The angle of contact of the cam with the follower is preferably adapted generate forces opposes to the string tension Preferably a slight change in angular contact at the neutral position provides tuning stability when the return spring 56 is properly adjusted, as previously disclosed.

The cam follower 55.9 rotates on a shuttle 56a (or alternatively a rocker) providing stable contact between cam 55 and cam follower 55.9 by confining the cam follower to a linear or arcuate path, and resisting unwanted tangential motion of cam follower about the cam.

The actuation arm 16c, substantially parallel to the strings in FIGS. 26A and 26B may alternatively have the shape of a cylindrical control surface (not shown), preferably coaxial with shaft 113a, and of sufficient radius and surface friction to enable a rolling action with the palm side of the fingers while playing.

In examples of alternative embodiments, the combination of arm 16, shaft 113a, and handle 16c, take the form of a full or partial drum surface as in FIG. 26C, or a contoured or substantially planar surface (for example a pickguard) hinged along an axis substantially parallel to the strings, as in FIG. 26D.

In alternative embodiments, the biasing means includes a cam and follower, at least one of which is moveable relative to a base, where rotation of the arm 16 is associated with relative motion of said cam and cam follower, such that rotating the arm 16 in one direction (preferably downward, away from the strings) alters the bias position of the main member 8 in a direction of increased bias spring force, for example similar to the device described with respect to FIG. 9C. Shaft 113a may connect directly or indirectly to said one or more cam, and may be configured to bend or swivel or link to intermittent arm or shaft means.

Bend Limiter

In the embodiments of FIGS. 23A and 23B a separately biased guide crank 220 is provided for at least one sting. It preferably rotates on a common axis 1 with main rotating member 8, and rests against a stop 222 relative to main member 8. As main member 8 rotates in a bend direction, guide crank 220 rotates with it under the force of separate bias spring 122, until preferably adjustable (by an adjusting screw, for example) stop 221 engages base 8. In the example, crank 220 comprises string anchor means 10, for example a slot positioned to enable string 4 to wrap over the surface of guide 6. In a preferred embodiment, a quickly changeable adjuster, for example a sloped or stepped axial cam 221a in FIG. 23A between stop 221 and base 69 (pivotable about an axis 221x), enables a user to quickly select from among 2 or more bend limits during a performance. The range of adjuster 221a preferably is sufficient to enable adjusting the limit to totally prevent bend (sharpening) motion of crank 220 relative to base 69. Adjuster 221a preferably comprises knob or lever means as shown to enable quick adjustment.

The separate crank 220 preferably includes string anchor means separate from the main member, for example a slot for receiving the ball end of a string, as shown, preferably far enough from the guide 6 to isolate the guide from the stiffness of ball end lashing. Main member may optionally be partially biased by separate balancing spring 40.

The radius of guide 6 from axis 1 may be adjustable, for example by set screws on a flexible guide bracket 220, as illustrated in FIG. 23C, or it may be fixed, for example as illustrated in FIG. 23A. A single fixed guide permits all other guides to be adjusted relative to the fixed guide to accomplish tuning of the device. Actuation effort may be adjusted by modifying the purchase of the actuator mechanism between the control arm and main member (not shown).

Neck Mounts

The application describes embodiments of a bracket and a method for connecting, a neck (in the prior to a guitar body in a manner leaving room for placement of the thumb of the fretting hand under the neck in the area of the connection.

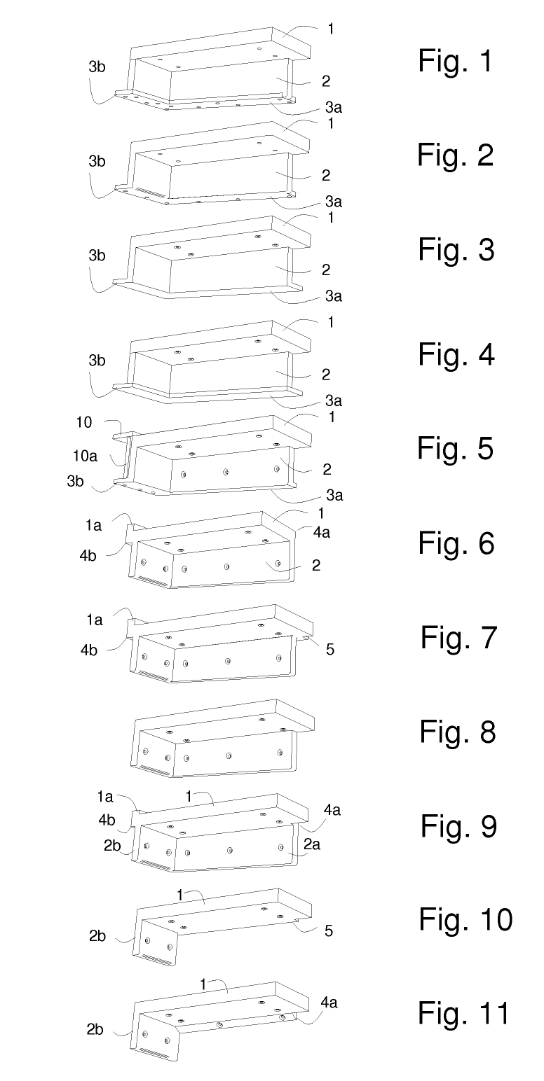

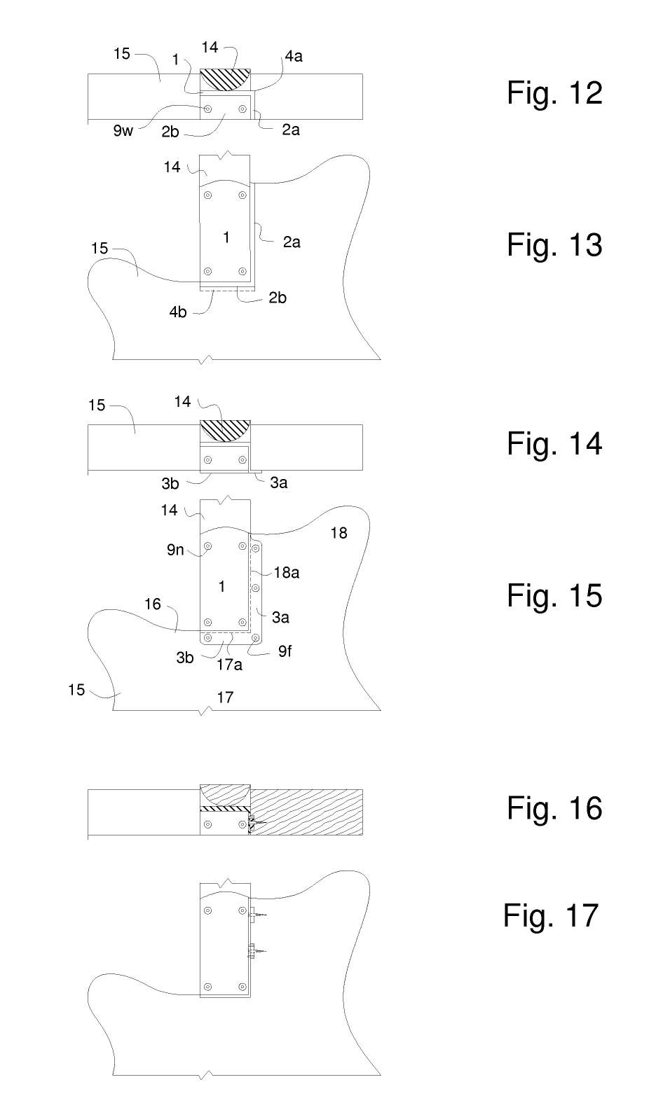

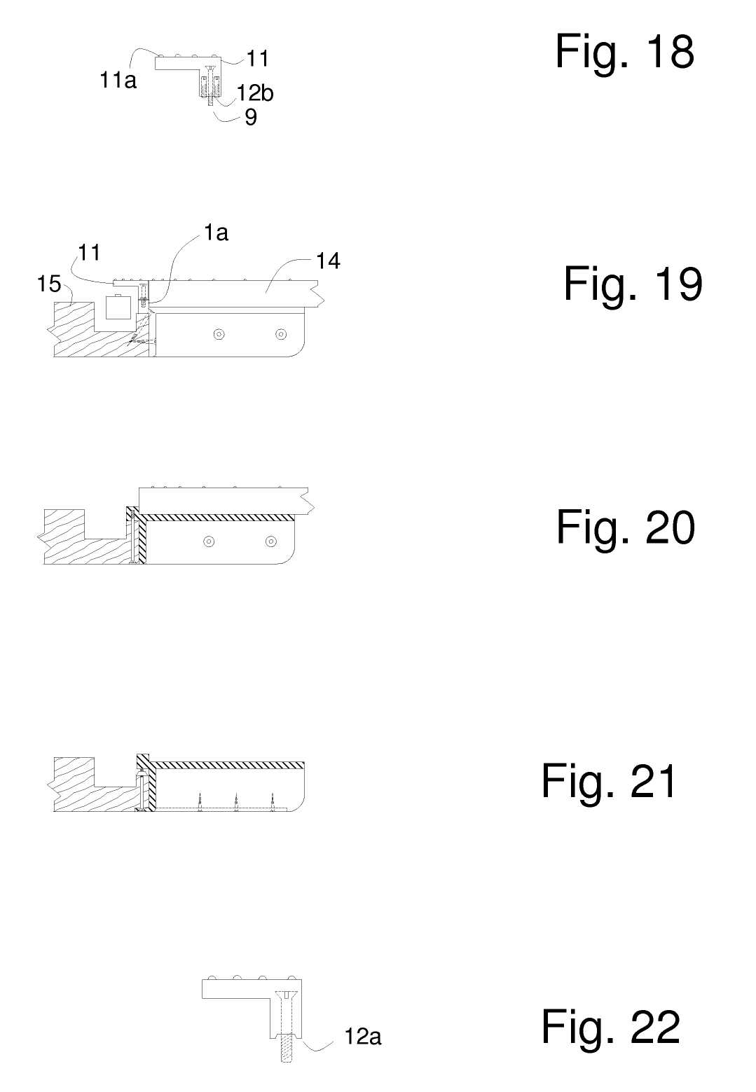

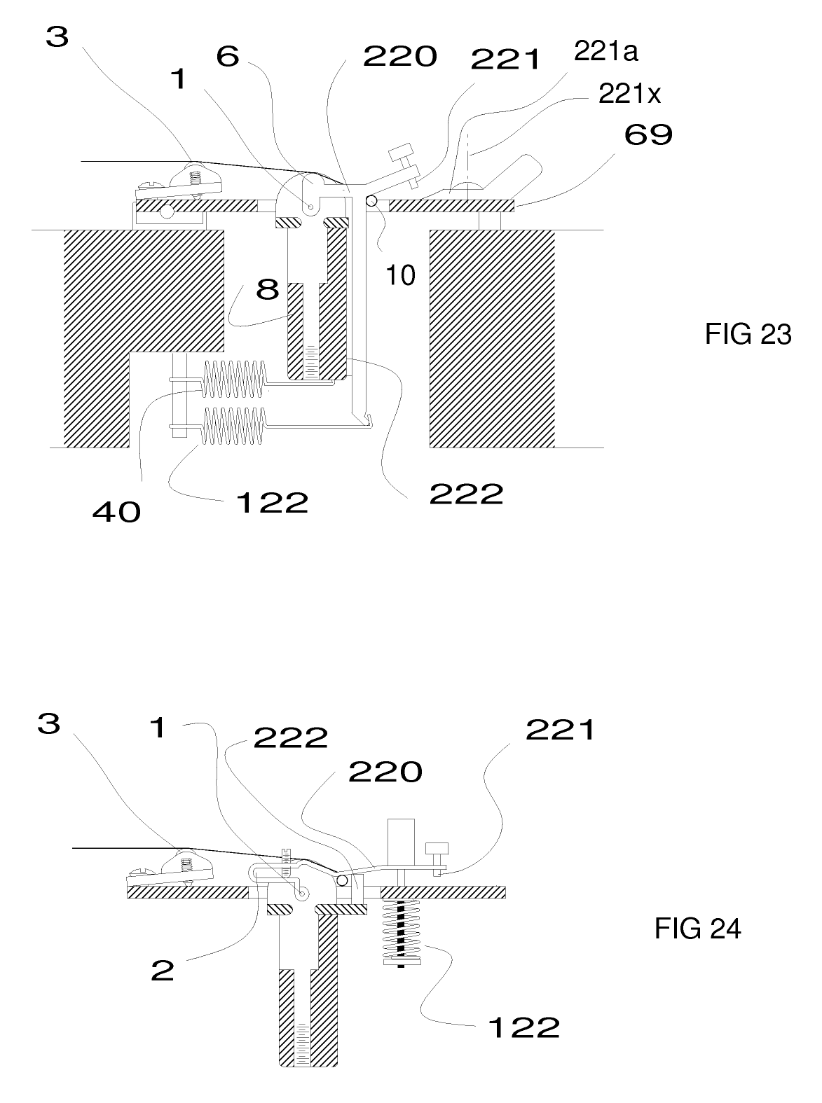

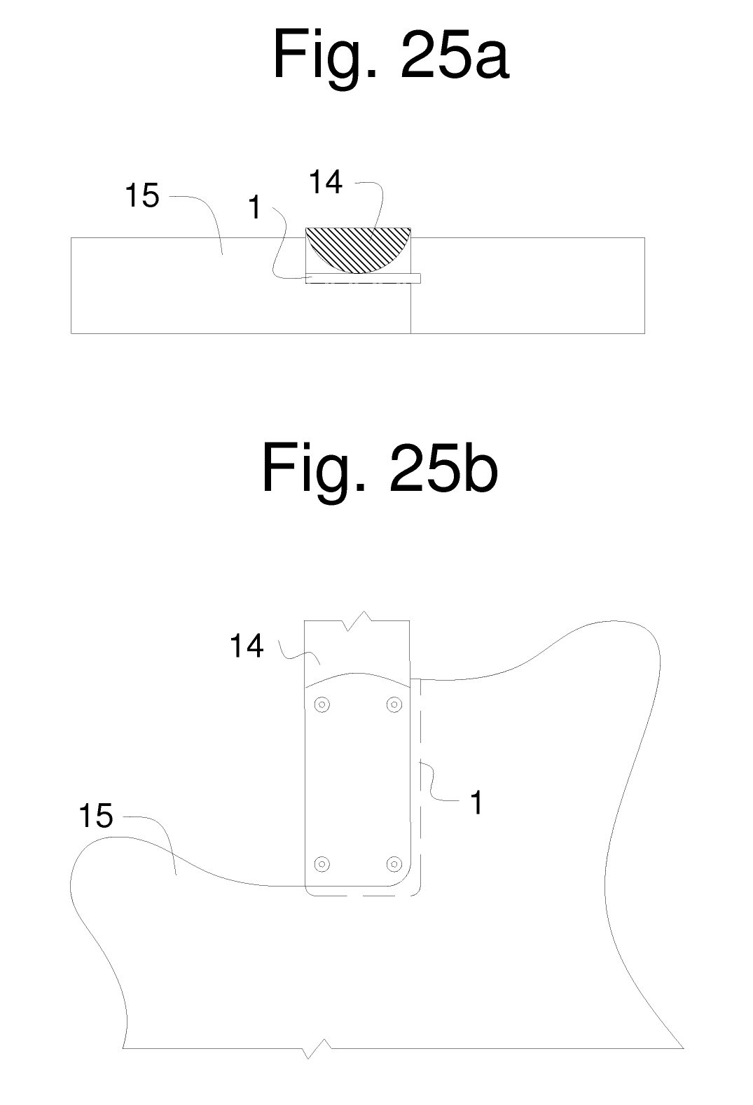

FIGS. 1 through 5 show embodiments of a bracket having a base 1, web 2, and front and rear flanges 3a and 3b. In FIG. 15 flanges 3a and 3b stabilizing the neck 14 by connecting it in a triangular pattern along a heel cut 17a and a longitudinal cut 18a in the forward most portion 18 of the body 15. Fasteners 9f in the figure secure the bracket to the body, while fasteners 9n (typically wood screws or machine screws) connect the neck to the bracket.

The bracket is preferably fabricated, cast, or assembled from high modulus material for example steel, aluminum, titanium, or carbon composite.

The higher modulus at the bracket allows a thin base on the order of 6 mm.

Alternative embodiments in FIGS. 6 through 11 utilize shoulders 4a and 4b or keys 5 (for example rectangular keys or discs) fitted to matching surfaces of the body. Keys may be stabilized to the bracket by, for example, pins 7, recess 8, precision screw shaft 6, or welding or press fit.

In the various figures, flanges 3a and 3b, or shoulders 4a and 4b, or keys 5, are preferably configured to mate with opposing surfaces on the guitar body in an orientation opposing motion in at least one direction normal to the face of the body 15.

An optional neck heel stop la also optionally supports an optional cantilevered fretboard extender 11, preferably connected by one or more screws. Height and angle of adjuster 11 may be adjusted by shims, machinable feet 12a, or setscrew feet 12b. Extender 11, preferably aluminum, includes frets 11a, preferably cast or machined into the extender.

In an alternative embodiment shown in FIGS. 23A and 23B, a single plate 1 of preferably a high modulus composite material (for example carbon-epoxy) is adhesively secured into keyways at the end and one side of the neck pocket of body 15. The plate is preferably molded or predrilled with holes for attachment to a neck, the holes preferably used in locating the plate in an assembly jig for adhesive bonding to the body.

I claim:

1) A device for changing the string tension on a stringed musical instrument having a body and multiple strings, said device operatively engaging at least two strings and comprising,
a base defined by or attached to said instrument body,
a first rotating member comprising a shaft, journal, or other bearing component rotatable about a first axis fixed with respect to said base and directly or indirectly engaging a first complement of at least one string such that rotation of said first rotating member induces a displacement in the engaged portion of said first string complement causing a change in string tension and pitch, where said change in pitch is related to the direction and degree of rotation,
a second rotating member comprising a shaft, journal, or other bearing component rotatable about a second axis fixed with respect to said first rotating member and directly or indirectly engaging a second complement of at least one string such that rotation of said second rotating member induces a displacement in the engaged portion of said second string complement causing a change in string tension and pitch, where said change in pitch is related to the direction and degree of rotation,
a control lever integral with or engaging said second rotating member such that rotation of said control lever about said first axis causes rotation of said first member about said first axis, and rotation of said control lever about said second axis causes rotation of said second member about said second axis,
where said first and second axes are substantially non parallel.

2) A device according to claim 1 where at least one of said first and second rotating members engages two or more strings.

3) A device for changing the string tension on a stringed musical instrument having a neck, a body and multiple strings, said device operatively engaging at least two strings and comprising,
a bridge discrete from or integral with said instrument,
a base defined by or attached to said instrument body,
first moveable member operatively engaging directly or indirectly at least one string such that motion of said first member relative to its base results in a change in the tension and pitch of said strings,
A second moveable member directly or indirectly engaging said stings such that movement of said second member results in a change in the tension and pitch of said strings,
mechanical coupling between said first and second members such that motion of said one of the two members results in motion of the other member.

4) A device according to claim 3 where said mechanical coupling further comprises
at least one adjuster adapted to characterize in a manner selected by the user the motion of said second member relative to the rotation of said first member.

5) A device according to claim 4 wherein the range of said adjusters enables adjustment such that the motion of said second member may substantially cancel the effect of neck movement on said string tension, where said neck movement is the result of changes in string tension caused by rotation of said first member.

6) A device according to claim 3 where said second member comprises shaft, journal, or radial or linear bearing components adapted to enable rolling, sliding, rotation or other defined motion relative to said first member.

7) A device according to claim 3 where said second member comprises at least one string anchor to secure one end of at least one said sting relative to said second member.

9) A device according to claim 3 where said first member comprises shaft, journal, or radial or linear bearing components adapted to enable rolling, sliding, rotation or other defined motion relative to said second member.

10) A device according to claim 3 where said first member comprises at least one string anchor to secure one end of at least one said sting relative to said first member.

11) A device according to claim 3 where said second member comprises at least one idler pulley engaging at least one said string between the engagements of said bridge and said first member with said string.

12) A biasing mechanism associated with a moveable component of a vibrato mechanism, said biasing mechanism comprising
a cam or cams having first and second operative surfaces
a cam follower or followers
a spring or springs adapted to force said cam and follower together
where cam and follower are configured such that the action of said cam follower against either of first and second cam surfaces results in either a substantially neutral force or a biasing force opposing the effect of string tension on said vibrato component.

13) A mechanism according to claim 12 comprising cam or cam surfaces configured such that the action of said cam follower against either of first and second cam surfaces results in a biasing force opposing the effect of string tension on said vibrato component.

14) A device according to claim 2
and further comprising at least one proportioner associated with at least one of said first or second rotating members,
said proportioner engaging a complement of at least 2 stings, such that upon rotation of its associated rotating member, said prortioner displaces the engaged portion of each said string at a different rate from the displacement of the remaining string or strings.

15) A device according to claim 3 where
said second moveable member comprises a plate substantially parallel to the plane of strings in the visinity of said plate, rotating on a second axis substantially normal to said plate,
where said plate engages at least a subset of said strings such that rotation of said plate about said second axis in one direction causes and increase in string tension, and rotation about said axis in the opposite direction causes a decrease in string tension.
Where said mechanical coupling comprises pivot or pivots, where said second member rotates on said second axis relative to said first member on a pivot or pivots associated with said first member,
Where said first moveable member is moveable axially or rotationally or both such that motion of said first member causes motion of said second member at least by direct engagement of said first member with said second pivot or pivots.
Such that motion of said first member causes a more uniform change in string tensions than rotation of said second member about said second axis.

16) A device according to claim 15, and further comprising an actuator mechanically associated with said first and second members, and a stop associated with said first and second members where
said actuator comprises surfaces adapted for direct or indirect manipulation by the user
said actuator includes a hub rotating on an axis fixed relative to said first or second members or relative to an axis connector pivoting on and axis fixed relative to said first or second member.
where rotation of said hub in one direction about its axis or said connector axis causes rotation of said second member in a direction increasing string tension.
And where engagement of said first and second members with said stop prevents rotation of said second member relative to said first member under the net force of strings and bias springs when said actuator is released.

17) A device for changing the string tension on a stringed musical instrument having a body and multiple strings, comprising,
a base defined by or attachable to said instrument body,
a plate rotatable relative to said base about an axis substantially normal to the plane of the strings in the region of said plate.
a control lever pivotable relative to said base and to said rotating plate and operatively engaging both said base and said plate
such that rotation of said control lever relative to said base or to said plate causes rotation of said plate about its axis.
such that tension in strings is increased or decreased, depending on the direction of rotation of said plate.

18) A device to alter the tension of a single string of a stringed instrument, said instrument having a vibrato mechanism comprising a first member pivotable about a main axis, said first member adaptable to change the tension of multiple strings in a manner substantially maintaining relative pitch when rotated about a main axis from a neutral position, said device comprising a lever, a guide associated with said lever, a pitch compensator, at least one adjuster adapted to position said guide or said compensator or both, and a fixed or adjustable limit adapted to prevent rotation of said lever beyond a desired change in string pitch, said components configured such that when said lever is rotated to said limit, said compensator and guide engage a string to change said string pitch by a user adjusted interval, and said guide locates the string at a user adjusted radius and/or angle from said main axis, where the range of adjustment enables said device to be configured to substantially maintain relative pitch of said string with adjacent strings as said first member is rotated about said main axis.

19) A device according to claim 18, and further comprising a spring component configured to rotate said lever to a home position, and an adjustable or fixed stop to stop said lever at its home position.

20) A device according to claim 19, and further comprising overcenter means to lock the device at one of two positions using string tension or spring force to lock resist rotation from said locked position.

21) A device according to claim 18, and further comprising a string anchor associated with said lever, such that said lever is adapted to transfer the tension of said string to said first member.

22) A method comprising:
Choosing a proprietary family of stings where the strings among all wound string gauges have a substantially constant value of mass/tensile modulus/core area across the entire family.
Choosing a target instrument model having a substantially known scale length and total string span.
Choosing a harmonic vibrato device having fixed or fixedly adjustable components.
Finding adjustment parameters for the chosen vibrato suitable for the chosen family of strings and for the target instrument model.
Providing notice with the shipped device of said chosen string family for which said parameters have been determined.
Performing one or more steps chosen chosen from a list comprising:
Providing instructions for adjusting the chosen vibrato according to the determined parameters for the chosen string family and the target instrument model or scale length,
Shipping the chosen vibrato preadjusted according to the determined parameters,
Shipping the chosen vibrato in fixed adjustment according to the determined parameters,
Shipping a set of strings from the chosen family with the chosen vibrato,
Providing a template or jig for locating string guides according to determined parameters.

23) A control device for a pitch changing mechanism on a stringed instrument, said mechanism comprising a first member adapted to alter the tension of at least two strings when said first member is moved in an operative direction relative to a base, said device comprising
at least one bias spring,
a bias limiter,
a lever pivotable about a first axis,
a bias connector, moveable relative to said base,
a latch adapted to lockingly engage said connector with said base,
said bias limiter comprising first and second components,
said connector mechanically associated with said first member and said at least one bias spring such that said said connector, under urging of said at least one bias spring, urges said first member in a direction of increasing string tension relative to said base,
said first component of said bias limiter associated with said connector,
said a second component of said bias limiter associated with said base,
motion of said connector in a direction of increasing string tension limited by engagement of said first and second components of said bias limiter,
engagement of said first and second components defining a biased position of said connector,
said lever configured to engage said first member and said connector such that rotation of said lever about said first axis in a first direction causes displacement of said first member from said bias connector in a direction of increased string tension,
said latch mechanism associated with motion of said first member or said lever, such that rotation of said lever in said first direction causes said connector to be latched relative to said base,
such that increased string tension from further rotation of said lever in said first direction will not substantially move said connector from said biased position.
